(19) United States
(12) Patent Application Publication
(10) Pub. No.: US 2004/0027253 A1
(43) Pub. Date: Feb. 12, 2004

(54) Automatic reading of a meter having a dial or numeric visual display

(76) Inventors: Douglas G. Marsh, Bethlehem, PA (US); Apparajan Ganesan, Venus, TX (US)

Correspondence Address: Douglas G. Marsh, 1031 Graham St., Bethlehem, PA, 18015, US

(21) Appl. No.: 10/314,469

(22) Filed: Dec. 9, 2002

Related U.S. Application Data
(60) Provisional application No. 60/402,614, filed on Aug. 12, 2002.

(51) Int. Cl. G08C 15/06

(52) U.S. Cl. 340/870.02

(57) ABSTRACT

An automatic meter reading uses information from existing dial or numeric display meters without any modification to the existing meter. Image detection is used to capture the meter image. Digital signal processing means are used to convert the image to characters by rotating, aligning, ordering, and comparing them to a stored character set as needed to represent the actual meter reading. Security based on a typical changes to the meter image can be provided by the same digital signal processing means. The results is the converted to binary form and transmitted using any of a wide variety of available means to a central base for storage, further analysis, and billing.

### CROSS-REFERENCE TO RELATED APPLICATIONS

Not applicable.

### BACKGROUND

1. Field of Invention

This invention relates to meter reading, specifically, to automatic reading of a meter having a dial or numeric visual display without replacing the meter.

2. Description of Prior Art

Numerous methods are available for automatic reading of various meters followed by transmission of the data by a wide variety of means including telephone lines, CATV cable, and RF links.

Examples of some of these are found in U.S. Pat. Nos. 5,136,514 and 6,313,756. Both of these patents disclose electric meter reading systems in which the data is read and transmitted by hardware that is physically separated from the meter. This improves the system reliability. However, in both patents, the meter itself contains optical electronics for passing the data from the meter to storage and transmitting block. The data being transmitted is already digitally encoded. Implementing these techniques requires that the existing base of purely mechanical meters be replaced by a new meter.

In U.S. Pat. No. 4,940,976 a means of reading a water meter is presented that uses magnetic flux to couple the data from the meter to a separate storage and transmitting unit. This allows the existing meter to be used. However, relying on magnetic flex limits the bandwidth of the reading to 0.1 gallons per minute. This translates to more than 4300 gallons per month, so water lost through a dripping faucet may not be detected or billed.

In U.S. Pat. Nos. 4,350,980 and 5,187,989 a count is performed by detecting a mark on a rotating plate. In the first patent, the technique does not require a new meter, but it is limited to electric meters. The second patent, for water, requires a new meter. U.S. Pat. No. 5,442,281 also is applicable to rotating disks and uses changes in reflection of electromagnetic energy due to the disk having regions of differing reflective properties, and this technique also requires a new meter.

In U.S. Pat. No. 4,881,070 radiant energy reflected off the dials of a meter is used to sense the angular position of the dials. The dials are specialized, requiring a new meter, and light is focused on the dials by lenses, adding to the cost.

In U.S. Pat. No. 4,688,038 phototransistors associated with each dial are arranged so that the detector not receiving the light indicates the dial position. This is applicable only to dial meters, and requires a new meter.

### SUMMARY

In accordance with the current invention, the dials or numeric display in any existing meter, whether or not the meter contains any electronics, are read by an image sensor that is contained in a unit separate from the existing meter. No changes to the existing meter are needed. By digital signal processing means, the images are converted to characters, which are then decoded by further signal processing and ROM lookup to binary data for transmission.

### OBJECTS AND ADVANTAGES

Accordingly, several objects and advantages of this invention are:

(a) to allow any existing meter can be automatically read;

(b) to retrofit to an existing meter requires only a few minutes;

(c) to have a sufficiently flexible means of automatic meter reading that a family of meter reading products can be developed for various applications; and

(d) to have a sufficiently flexible means of meter reading so integrated circuit vendors, meter suppliers, local utilities and other users can make appropriate cost and feature tradeoffs.

### DRAWING FIGURES

FIG. 1 shows a very general embodiment of the invention.

FIG. 2 shows an embodiment of the invention wherein various functions shown in FIG. 1 are either changed to a different technology or are eliminated.

FIG. 3 shows the electronics located on the meter side of the connecting arrangement of FIG. 2.

### DESCRIPTION —PREFERRED EMBODIMENT

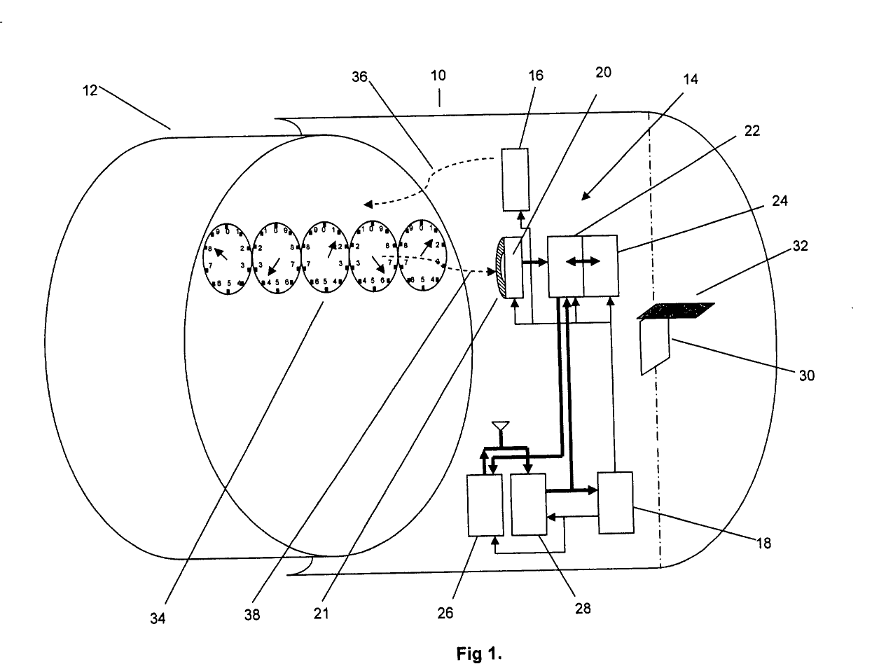

A general embodiment of the invention is shown in FIG. 1. The system includes a means of using a shroud 10 to connect the reader electronics 14 to the meter 12, a light source 16, a battery power supply 18, an image detector 20, a digital signal processor (DSP) 22, an image analysis program ROM 24, a signal transmitting unit 26, and a receiver 28. The shroud 10 may contain an opening 30 which may have a flap 32 or other cover means. The opening 30 may be used to visually inspect the meter dials 34 should there be any question as to the accuracy of the detected reading. The image detector 20 can use the same image sensing and lens technology as is used in digital camcorders and digital cameras. All CMOS image sensing is becoming available, allowing a very high degree of integration. The ROM 24 contains both an image analysis program and a table lookup to allow a very wide range of numeric characters to be understood.

When a meter read is requested, light 36 from the light source 16 illuminates the face of the meter. The reflected light 38 showing the dials 34 is focused through a lens 21 and is captured by the image sensor 20. Image analysis by the DSP 24 converts the picture to numerical data. The details of the process of converting the picture to numerical data will vary depending on the display of meter. Here, a dial 34 type meter, typical of electric meters, is shown. Some electric meters have seven segment display readouts. Water meters commonly use rotating wheels with numbers on them for the data readout. Those skilled in the art will realize the reading capability of this invention is not limited to dials and numerals. Any arbitrary set of letters, numbers, or other characters in any language can be supported so long as they are defined in the character set in the ROM 24. For simplicity, further discussion may often use only the term dial or numeric display, but it will be understood to mean any display.

Those skilled in the art will recognize that tradeoffs can be made between placing limits on the character set and the complexity of DSP program used to scan the ROM 24 to find the correct character set. The character set can be limited simply by limiting the ROM 24 space, or well known electronic means, not shown or described further here, can be used to select a subset of the total ROM character set that the DSP may search in a given application. The DSP program can also be stored in the ROM 24.

Examples of some tradeoffs might be: Vendor number one might choose to serve only the US electric dial meter market. Since only one character set is used, and these meters use five dials, the pattern matching is limited, and a custom DSP 22 with a hardware defined character set (i.e., no ROM 24 would be needed) would result in the small silicon. This vendor might choose a single image detector 20 and a strap attachment rather than a shroud 10. The lens 21 needed to read images spread over five by one inch area on the meter face 24 only a one inch deep from the image detector 20 might be complex. A second vendor might choose the same application, but would use several image sensors 20, with less demanding lens 21 requirements. More image sensors might also result in a simpler DSP 22. The expectation of vendor two is that the increased cost of more image sensors 20 and lenses 21 would be more than offset by the smaller DSP 22 silicon and the reduced complexity of the lenses 21. Yet a third vendor might target both dial electric and water meters. Two character sets would be needed, and the operations in DSP 22 would be more complex. This vendor might choose a core DSP 22, many of which are readily available in the libraries of integrated circuit manufacturers. This vendor would be expecting that competition between various core suppliers and the higher volume of two applications would offset any intrinsic higher cost due to larger silicon.

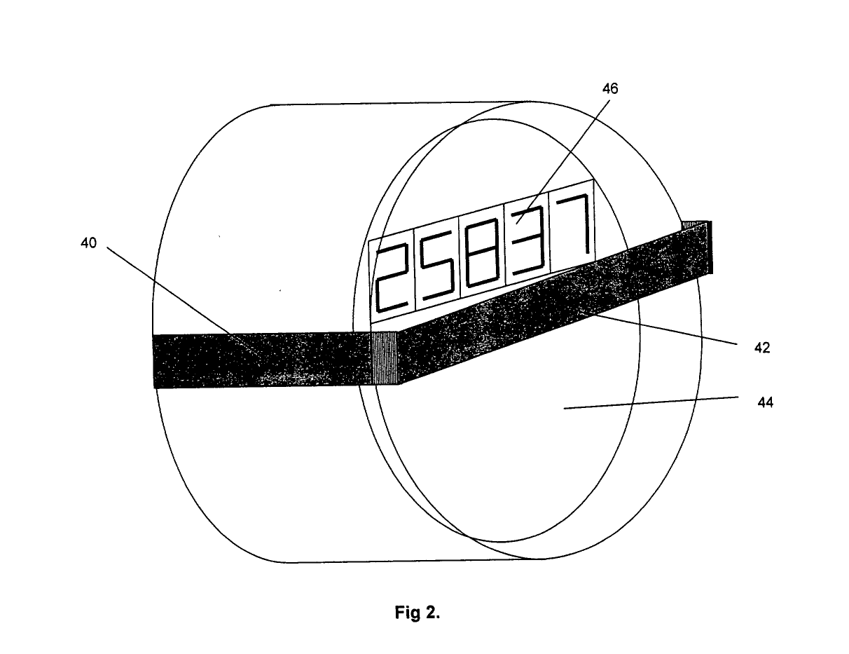

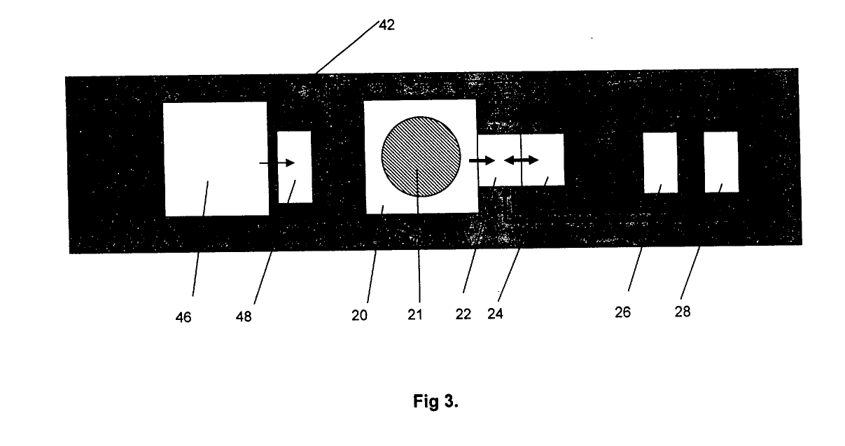

A second embodiment of the invention is shown in FIG. 2 and FIG. 3. The shroud has been replaced by a connecting strap 40. The strap 40 is placed so that the numerals 46 are easily visible. All the needed electronics are located on the meter side of the strap 40 shown in FIG. 3. The light source has been eliminated assuming an outside location. Ambient light reflected off the face of the meter 42 is sufficient to enable the image detector 20 to read the numerals 46 through the lens 21. For the power supply, the battery is replaced by a photovoltaic converter 46 used to convert reflected ambient light to electrical energy which is then stored by any well known electronic means 48. The conversion of light to stored electrical energy can use the same technology as in employed in solar powered watches. This stored energy enables the system to transmit readings at night. Ambient light is more than sufficient for many applications having a read duty cycle of less often than once every few minutes.

In both embodiments, a receiver 28 is shown. The purpose of the receiver 28 as related to this specific invention is to receive a command to initiate a read and transmit the data. By use of a timing circuit, not shown since it is easily incorporated into the DSP 22 or the program in the ROM 24, the meter reader could automatically decide when to read and transmit. This may be acceptable in applications where the data is locally collected from a few sources and then retransmitted. However, as the number of meters increases and the distance to the final collection point increases, problems of simultaneous transmission from several meters or of the final collection point being out of operation become complex. The choice will be application dependant.

Above, two means of powering the meter reader have been described, a battery 18 and a photovoltaic converter. Those skilled in the art will recognize that any number of other power means could be used including, but not limited to, line power that is appropriately locally converted to the needs of the specific implementation and thermoelectric powering such as is described in U.S. Pat. No. 4,940,976.

An important aspect of many applications using automatic meter reading is security. The use of DSP technology offers a means of offering security. Angular information, rotational information and information regarding distortion through the face of the meter are some of the parameters that may be used for security. An initiation sequence embedded in the ROM 24 requiring only a few seconds would be performed by the installer. This sequence would set the initial security information. Subsequent minor changes in these parameters are differentiated from the allowed dial or numeric display changes to detect tampering with the meter reader. In addition to security based on DSP technology, other means of added security could be added, limited only by the creativity of those implementing this invention, for example building connectivity sensing into the strap.

To further increase security, internal reads can be done frequently. In the ambient light power arrangement, the reads are low power operations compared to transmission. The time between reads can be made sufficiently short as to negate any chance of tampering. In environments without ambient light, the power needs for the more frequent illumination and read operation need to be calculated and the power supply designed accordingly.

The large number of total meters and applications to which this invention is applicable will make integration of the electronics attractive to many integrated circuit vendors. Various vendors will focus on different collections of meter suppliers and utilities. Various choices, some outlined above, regarding the character set in the ROM 24 versus program tradeoffs and security issues would be implemented and marketed in different ways for different products. The level of integration will also be vendor dependant. Combining the DSP 22 and the ROM 24 in the same silicon chip is obvious. Merging the image sensor 20 in the same die is technically feasible today in the case of a single image sensor 20, but lens 21 and package issues may affect this choice. The combination of image sensing 20 and DSP technology 22, 24 enables this diversity.

The results of the DSP 22 operations are the capturing of both the meter reading and of any attempt at tampering. This information is easily converted to binary form and transmitted using any of a wide variety of available means, which are well known and not part of this invention, to a central base for storage, further analysis, and billing.

Those skilled in the art will recognize that there is no requirement that the DSP 22 and ROM 24 functions be located in the same physical housing as the image sensing 20 functions. It would be an option to place the DSP and ROM 22,24 functions at the site to which the information is transmitted. In this case, the raw data from the image sensor 20 is transmitted. This can result in a cost reduction since the electronics placed at the site of the meter are simplified, and a shared signal processor can be used at the data collection site. Transmission time is increased, especially of multiple image sensors are used. The number of bits required per pixel is application dependant. Security issues could to be dealt with in similar ways.

Those skilled in the art will also recognize that it is not required that any of the functions involved in this invention be attached to the meter. It would be an option to include any of the above described operations in a hand held unit. In this case, the meter reader still visits the site, but uses a hand held unit to take the image of the meter. The data is either stored in the hand held unit until the hand held unit is returned to the central facility for processing, of RF means may be used to transmit the information to the central facility. While this option does not eliminate the cost of the meter reader, nothing needs to be attached to the meter, and the time required by the meter reader is reduced, reducing cost.

In addition to using this invention to send information to the utility company, the information can be sent to the customer. This transmission can use the same techniques as are used by the utility. The transmission can also use other means, such as by having the relatively short range Blue Tooth technology, which could be part of the transmitter unit 26, the receiver unit 28, or a separate function. Customer could read the meter frequently, and use the result for various load balancing decisions.

The image detection and conversion to easily transferable digital information via signal processing techniques embodied in this invention are not limited to reading meters. A personal computer with a scanner and/or a camera with resident appropriate software could be used to read meters such as a diabetic's glucose meter, a digital thermometer, etc., and output the result for further transmission or processing. This avoids the need for adding interfaces on those meters that might otherwise be needed to enter the information into a computer.

Advantages

From the description above, a number of advantages of this method of automatic meter reading become evident:

(a) any existing meter can be automatically read;

(b) retrofitting an existing meter requires only a few minutes; and

(c) a family of meter reading products can be developed for various applications so that integrated circuit vendors, meter suppliers, and local utilities and other users can make appropriate cost and feature tradeoffs.

Conculsions, Ramifications, and Scope

Accordingly, it is evident that this invention offers a low cost means of performing automatic meter reading to almost any location in the world for almost any of the massive base of existing installed dial or numeric display type meters.

We claim:

1. A method of providing a module for automatic reading of dial and numeric display meters using image sensing and digital signal processing means whereby the image sensor can view the existing meter so that the existing meter is not changed.

2. The method of claim 1 proving the image sensing function and the digital signal processing functions are co-located in the attachment to the meter.

3. The method of claim 1 proving the digital signal processing function is located remotely from the attachment to the meter whereby raw meter image data is transmitted by any well known means to the remote location of the digital signal processing function.

4. The method of claim 1 providing matching of the detected characters to ROM stored character sets.

5. The method of claim 1 providing a level of security based on changes in the detected image not corresponding to changes in the dials or numeric display.

6. The method of claim 1 providing a light source in the absence of sufficient ambient light.

7. The method of claim 1 providing power from various means including, but not limited to, line power means, battery means, photovoltaic means, or thermoelectric means.

8. The method of claim 1 providing various means of attaching the module to the meter by means such as a hinged shroud, a shroud with a viewing means or a strap which does not obstruct the dials or numeric displays whereby the dials or numeric displays can still be read manually.

9. The method of claim 1 wherein various displays are read by various computer image interfaces and converted by software in the computer into data directly used for further information processing or transmission.
